(19) United States
(12) Patent Application Publication
(10) Pub. No.: US 2009/0030973 A1
(43) Pub. Date: Jan. 29, 2009

(54) Job Board/HRIS Integration and Selective Sharing of Interview Responses

(75) Inventors: Michael Allen Farber, Moorestown, NJ (US); Hal Marc Cohen, Cherry Hill, NJ (US)

Correspondence Address: MORGAN LEWIS & BOCKIUS LLP, 1111 PENNSYLVANIA AVENUE NW, WASHINGTON, DC, 20004, US

(73) Assignee: TREND INTEGRATION LLC, Cherry Hill, NJ (US)

(21) Appl. No.: 12/030,121

(22) Filed: Feb. 12, 2008

Related U.S. Application Data
(60) Provisional application No. 60/900,863, filed on Feb. 12, 2007.
(60) Provisional application No. 60/906,675, filed on Mar. 13, 2007.
(60) Provisional application No. 60/906,882, filed on Mar. 14, 2007.

(51) Int. Cl. G06F 15/16

(52) U.S. Cl. 709/203

(57) ABSTRACT

A system and method to collect, transmit and access user information from an information collection system. User information is received with is submitted by a user in response to a posting of an opportunity made at a host web site. In response to receiving the user information, the user is transmitted a confirmation page comprising one or more tags. The one or more of the one or more tags are used in connection with enrolling the user with an information collection system by transmitting user identifier and user contact information to the information collection system. The enrolling step is accomplished without activity by the user. The one or more of the one or more tags are invisible or visible to the user. Data is collected from the user in response to one or more questions posed to the user. Access is provided to the user information and the user data to the sponsor through an access page. The access page includes a tag that visually indicates to the sponsor a status of data collection from the user. The sponsor activates the tag to thereby access the user data by the sponsor.

### CROSS-REFERENCE TO RELATED APPLICATIONS

The present application claims priority to U.S. Provisional Patent Application No. 60/900,863, filed Feb. 12, 2007. “Job Board/HRIS integration and Selective Sharing of Interview Responses.” U.S. Provisional Application No. 60/906,675, filed Mar. 13, 2007, entitled “Job Board/HRIS Integration and Selective Sharing of Interview Responses.” and U.S. Provisional Patent Application No. 60/906,882, filed Mar. 14, 2007, entitled “Job Board/HRIS Integration and Selective Sharing of Interview Responses,” each of which are incorporated herein in its entirety by reference.

### FIELD OF THE INVENTION

The present application relates generally to systems and methods for enrolling, users in an information collection service and for providing access to user information stored in the information collection service via a web based system.

### BACKGROUND OF THE INVENTION

The widespread use of the Internet has enabled the rapid collection and exchange of many different types of information that can be delivered in a variety of mediums. Therefore a real need exists for a system that allows the user to leverage the power of this communication technology in the context of collection and analysis of information required for many different business and personal decision-making processes.

### SUMMARY OF THE INVENTION

The present invention provides for a method and system that enrolls a user with an information collection system. User information is submitted by a user in response to a posting of an opportunity at a host web site. In response to receiving the user information, the user is transmitted a confirmation page that includes one or more tags. The tag is used in connection with enrolling the user with the information collection system. In particular, it is used to transmit a user identifier and user contact information to the information collection system. The enrolling step is accomplished passively. i.e., without activity by the user.

The present invention further provides for a method and system that provide access to user data and contact information. User information is collected from a user in response to a posting of an opportunity by a sponsor and is stored. Access to the user information is provided to the sponsor through an access page. The access page includes a tag that visually indicates to the sponsor a status of data collection from the user. The sponsor activates the tag to thereby access the user data by the sponsor.

### BRIEF DESCRIPTION OF THE DRAWINGS

FIG. 1 illustrates an exemplary system used to perform the methods of the present invention.

FIG. 2 illustrates an exemplary web application form for submitting user information via a host web site.

FIG. 3 illustrates a graphical user interface showing a confirmation page sent to a user in accordance with the present invention.

FIG. 4 illustrates a graphical user interface for displaying a user's status and accessing the user's responses to questions posed by a information gathering system.

FIG. 5 depicts a graphical user-interface for selectively reviewing verbal responses of users.

### DETAILED DESCRIPTION OF THE PREFERRED EMBODIMENT

The present invention provides the user with a flexible, efficient system for the timely collection and analysis of information required to make a variety of important business and/or personal decisions. Examples of the diver-se environments in which the system can be applied include but are not limited to: job applicant interviewing and hiring; college applicant interviewing and acceptance; collection, reporting and analysis of heath care services: collection, reporting and analysis of information in the context of personal dating services; collection, reporting and analysis of information in the context of product surveys; collection, reporting and analysis of census data; and collection, reporting and analysis of information from polling results of candidates running for political office. Thus, the system architecture works equally well for many types of data collection, retrieval and analysis processes.

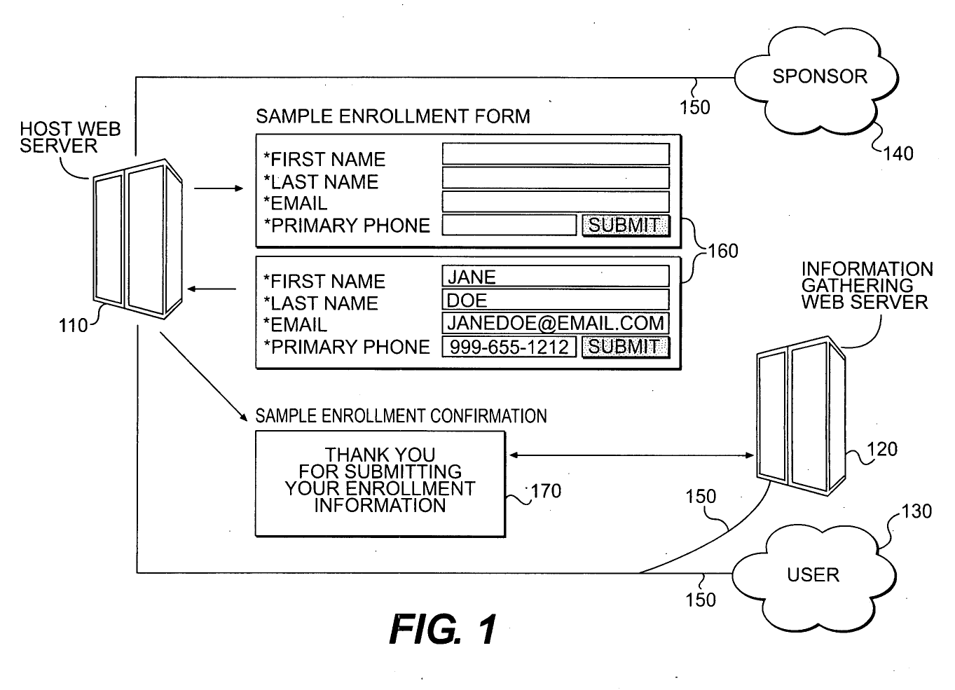

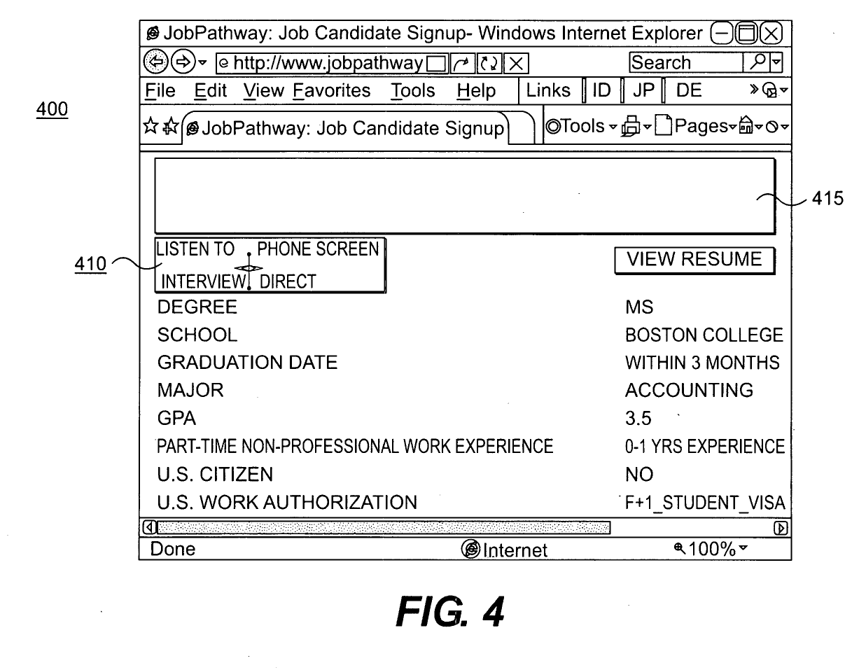

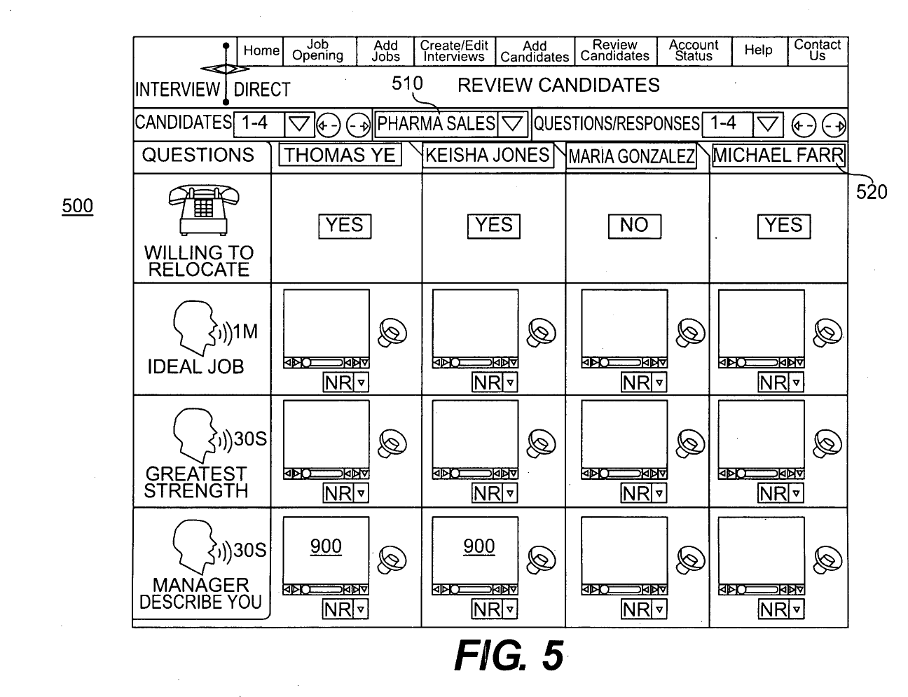

FIG. 1 illustrates an exemplary system for implementing the methods of the present invention. The exemplary system of FIG. 1 includes a host web server 110 an information gathering server 120, a user access device 130, a sponsor access device 140, internet 150, a web application page 160 and a web confirmation page 170. The host web server may present to the user the web application page 160 and web confirmation page 170 when the user accesses the host web site via the internet 150. The host web server may present to the sponsor one or more graphical user interfaces or web pages with examples of such shown in FIGS. 4 and 5. The system may perform the methods of the present disclosure in real time or in scheduled batch transmissions.

Host web site 110 posts a variety of opportunities for which a user may submit information. The opportunities may be posted at the request of a sponsor which desires information from one or more users. As referenced above, examples of diverse opportunities include employment opportunities, college admission, enrollment in medical provider services, product surveys, heath care survey, political polls, dating surveys, census surveys, entertainment surveys, etc. Examples of diverse sponsors include employers, college admission office, product manufactures, government officials, health care providers, product manufactures, pollsters, dating services, etc.

The exemplary web based system of FIG. 1 provides for the collection, transmission, and access to the responses of users to questions presented by an information collection system. In one embodiment, the information collection system may be operated by the sponsor who posted the opportunity at the host web site. In another embodiment, the sponsor posting the opportunity may contract with the information collection system to conduct the information gathering, process. Although the user submits its application through the host web site in the exemplary embodiment, the users' response to questions posed by the information gathering system can be presented and obtained through non-web based means such as described below.

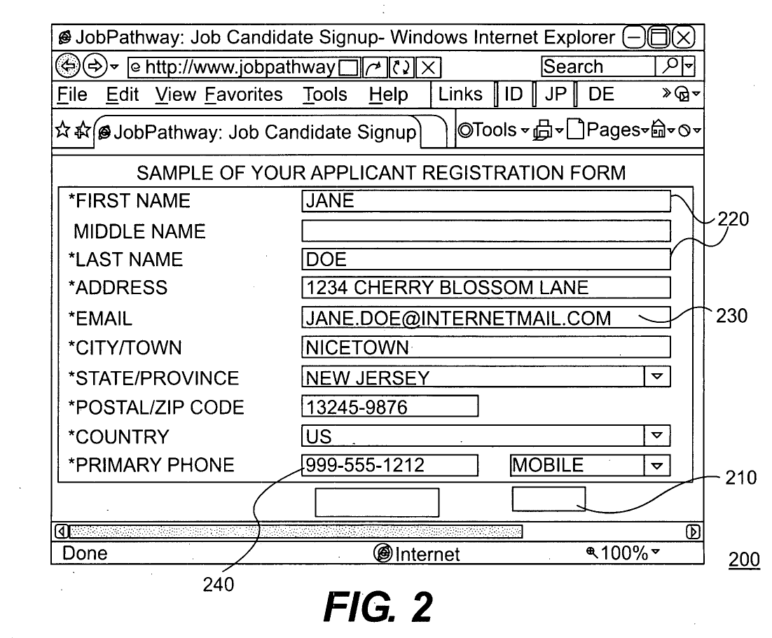

In accordance with the present invention, a user (e.g., candidate, applicant or respondent) completes a web application pace posted at the host web site by a sponsor which desires information from the user. The web application page may include fields that the user can input data or dropdown menus. FIG. 2 shows an exemplary application form 200 which includes areas for entering user information such as a user's name 220, phone number 240, and email address 230, as well as any other requested information. The transmission of the user application information can be achieved in a variety of ways, including but not limited to a standard Web URL, HTTP Messaging and Web Services.

Upon submitting the user application form, the web server associates a unique user identifier (“UUID”) with the user name and/or email address and/or phone number and/or other contact information. The identifier corresponds to information related to the posting to which the user submitted its information. For example, the identifier may correspond to the employer, college, medical provider, product, political user, dating service, government sponsor, etc. In the context of the identifier corresponding to an employer, the identifier may also correspond to additional information such as employment location or employment types. In the context of a product, the identifier may correspond to the manufacture, time and place of distribution. In the context of the identifier corresponding to a college, the identifier may correspond to additional information such as a user's course of study, need for financial aid, undergraduate or graduate student, transfer student, etc. In the context of the identifier corresponding to a political user, the identifier may also correspond to political affiliation, age, gender, ethnicity, etc.

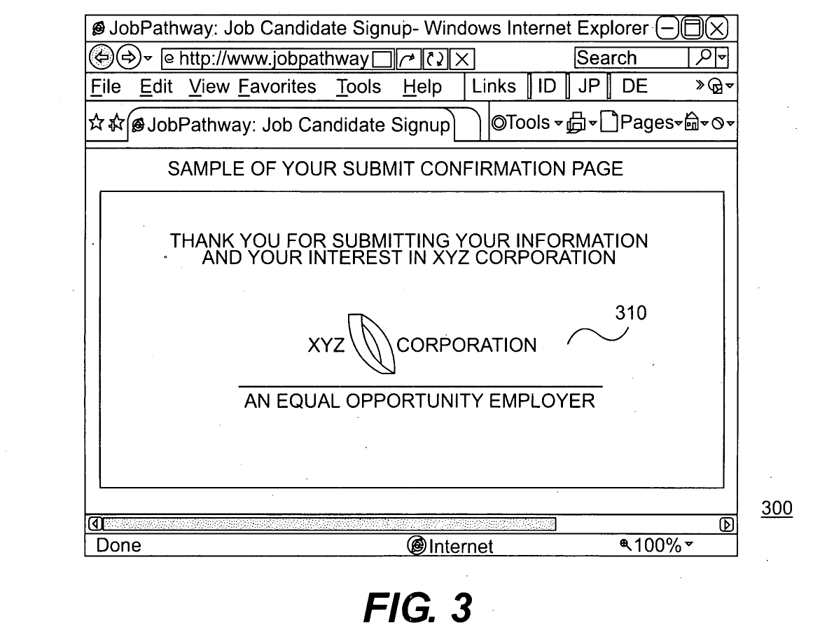

In response to receiving the user information, the host web server transmits a web confirmation page to the user. The web confirmation page includes one or more tags. For the purposes of this application, a tag means a single or multipurpose metadata embedded component of an electronically rendered graphical user interface. The tags may take the form of a visible image tag or invisible image tag. FIG. 3 shows an exemplary confirmation form 300 with a visible image tag 310. The image tags are used in connection with passively enrolling the user with an information collection system by transmitting the user information and user identifier to one or more information collection sites. For the purposes of this application, passive enrollment means the enrolling is accomplished without activity by the user. An exemplary HTML embedded within the visible or invisible image tag is set forth below:
<img href=”https://id.com/AppSignup.aspx?UUID=587B3-AXJ74&fname=Jane&Iname=Doe&emial=JD@imail.com&phone=999-555-1212>

Following enrollment, the user may participate in the opportunities posted on the host web site by contacting the information collection service or, instead, the user may be contacted by the service. To allow the user to contact the service, the confirmation page may display a phone number which allows the user to access or contact the information gathering system. In another embodiment, the confirmation page may display the phone number and a PIN associated with that user which in combination allows the user to access the information gathering system. The PIN may be created by a server associated with the information collection system based on the user enrollment information.

The information gathering system may present one or more questions to the users through a variety of means such as automated interviews via the internet, email contact, automated interactive voice call centers, voice call centers, telephonic surveys, one-on-one personal surveys, web surveys, mail surveys, etc. The questions presented to the user may include: questions specifically designed for the user; generic questions presented to each user enrolled for a posting; or questions developed during the course of the user interview. In one embodiment, the user questions are prepared by a server associated with the information collection system which associates the user's identifier with a group of prerecorded interview questions stored in a database of the information collection system. Because the identifier contains information related to the posting to which the user enrolled, the server can associate prerecorded interview questions that are appropriate for the posting.

In one embodiment, the questions may be posed to the user using an interactive voice response unit having the ability to record and store a user's verbal and/or touch tone responses. The user can access the prerecorded interview questions by contacting the information collection system with the provided phone number or phone number plus PIN. The interactive voice response unit will prompt the user with the selected interview questions and the user can submit verbal and touch-tone responses. The user's verbal and touch-tone responses may be stored in a database of the information collection system and/or a database of the host web site.

After the user has completed the questions, die user's responses are collected and stored in a database of the information collection system and the database is updated to indicate the submissions. In one embodiment, the information collection system may also analyze the user's responses. The information collected from the user may take a variety of diverse formats including audio, video, audio/video, text, graphic, images, biometric, or any other medium that can be stored electronically.

The stored user's responses are associated with the user information and user identifier (“associated responses”). In one embodiment, the associated responses are stored in a database of the data collection system. In another embodiment, the associated responses are stored in a database or the data collection system and a database of the web host.

Following submission of the user's responses to the data collection system, the sponsor responsible for posting the opportunity can access the associated responses. In one embodiment, the sponsor can include all employer, a recruiter, a human resource manager, etc. In one embodiment, the sponsor's access to the user's responses are made available through the host web server. The sponsors access to the host's web server may be provided by sending the sponsor an email having a link, an initial search screen on the host web server, web links activated by the sponsor, or other means. The sponsor's access to the user's responses may be accomplished by configuring the host web site to pass the UUID to the data collection system which may associate the UUID with the status of the user. This is accomplished via the exemplary graphical user interface of FIG. 4. The sponsor is presented a graphical user interface 400 including an indicator 410 on the sponsors web browser, FIG. 4. In one such embodiment, the indicator 410 includes a dynamic disposition display in the form of an image tag. The disposition display may indicate the user status with each status having an associated graphical image. Exemplary, user status could include, “Interview Not Yet Taken”. “Interview Submitted”. “User Rejected”, “User Advanced”, etc. Depending on the user status, the user's web page will display appropriate image tag for the user status. An exemplary image tag is set forth below:

<A HREF=https://id.com/AppInterview.aspx?UUID=587B3-AXJ74
target=“_blank”>
<IMG HREF=”http://id.com/StatusIcon.aspx?UUID=587B3-AXJ74></A>

The disposition display also permits the sponsor to access the stored user responses. In one embodiment, the sponsor may access one or more responses obtained for a single user by providing the UUID. In another embodiment, the sponsor may access a response of two or more users, wherein the users had responded to the same question, or different questions, by providing the UUIDs for the two or more users. The user responses may be presented to the sponsor by means appropriate for the collected responses. The diverse means may include streaming video, streaming audio, text display, image display, biometric display, or any other information that can be rendered electronically.

In one embodiment, a second graphical user interface is presented to the sponsor upon activating the image tag. An exemplary second graphical user interface is shown in FIG. 5. This exemplary graphical user interface enables the sponsor to listen to each of the job interview questions and associated job user's responses by selecting various icons shown by the second graphical user interface. Through these pages, the user can also rate the user responses. In addition, the second graphical user interface will display text associated with any of the job user's touch-tone responses. An exemplary second graphical user interface is shown in FIG. 5 and described below in the text associated with the figure. In this way the user can quickly and easily compare the responses of all users for a particular job to the same interview questions.

In yet another embodiment of the present invention, a sponsor is presented with the ability to select a specific user's interview responses or group of users' interview responses (“selected user responses”). The selected user responses may represent a subset of users that have enrolled for a particular opportunity using the methods of the present invention. In some instances, the selected users have passed an initial screening performed by, the sponsor. In other instances, the sponsor has not prescreened the selected users. The sponsor may then enter an email address of a third-party (e.g., a hiring manager who uses the recruiter to perform initial screening of applicants for a position) to whom access to such selected applicant responses will be provided. In one such embodiment, the host web server will automatically send an email to the third party. The content of the email can be customized, but may contain a unique user ID and password to enable the third-party to access the selected user responses via the communication system.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

1. A method comprising:
receiving user information, via a web page, submitted by a user in response to a posting of an opportunity;
in response to receiving the user information, electronically transmitting to the user a web page confirming submission of the user information, said web page comprising one or more tags,
wherein one or more of the one or more tags are used in connection with enrolling the user with an information collection system by transmitting a user identifier and user contact information to the information collection system,
wherein the enrolling to the information collection system is accomplished without activity by the user.

2. The method of claim 1 wherein one or more of the one or more tags are invisible to the user.

3. The method of claim 1 wherein one or more of the one or more tags are visible to the user.

4. The method of claim 1, wherein the transmission of said user contact information includes at least one of a user name, a user email address, a user phone number, a user residential address, a user business address, and other user contact information.

5. The method of claim 1, wherein said web page for submission of user information is made at a web site hosted by a third party.

6. A method comprising:
storing user information collected from a user in response to a posting of an opportunity,
wherein, in response to receiving the user information, a web page confirming submission of the user information is transmitted to the user, said web page comprising one or more tags, wherein one or more of the one or more tags are used in connection with enrolling the user with an information collection system by transmitting a user identifier and user contact information to the information collection system, wherein the enrolling to the information collection system is accomplished without activity by the user;
in connection with said enrollment with the information collection system, collecting data from the user in response to one or more questions posed to the user; and
providing access to said user contact information and said user data through a web page,
wherein said web page comprises one or more tags used to visually indicate a status of data collection from the user.

7. The method of claim 6, wherein one or more tags are activated to access one or more of the following: one or more elements of said user data and one or more elements of said user contact information.

8. The method of claim 6, wherein the stored user data is associated with one or both of a user identifier and user contact information.

9. A method comprising:
receiving user information submitted by a user in response to a posting of an opportunity via a web page;
wherein, in response to receiving the user information, a web page confirming submission of the user information is transmitted to the user, said web page comprising one or more tags, wherein one or more of the one or more tags are used in connection with enrolling the user with an information collection system by transmitting a user identifier and user contact information to the information collection system, wherein the enrolling to the information collection system is accomplished without activity by the user.

10. The method of claim 9 wherein one or more of the one or more tags are invisible to the user.

11. The method of claim 9 wherein one or more of the one or more tags are visible to the user.

12. The method of claim 9, wherein the transmission of said user contact information includes at least one of: a user name, a user email address, a user phone number, a user residential address, a user business address, and other user contact information.

13. The method of claim 9, wherein said web page for submission of user information is made at a web site hosted by a third party.

14. A method comprising:
collecting user information from a user in response to a posting of an opportunity by a sponsor,
wherein, in response to receiving the user information, a web page confirming submission of the user information is transmitted to the user, said web page comprising one or more tags, wherein one or more of the one or more tags are used in connection with enrolling the user with an information collection system by transmitting a user identifier and user contact information to the information collection system, wherein the enrolling to the information collection system is accomplished without activity by the user;
in connection with said enrollment with the information collection system, collecting data from the user in response to one or more questions posed to the user; and
providing access to said user contact information and said user data through a web page;
wherein said web page comprises one or more tags used to visually indicate the status of data collection from the user.

15. The method of claim 14, wherein one or more of the one or more tags are invisible to the user.

16. The method of claim 14, wherein one or more of the one or more tags are visible to the user.

17. The method of claim 14, wherein the transmission of said user contact information includes at least one of: a user name, a user email address, a user phone number, a user residential address, a user business address, and other user contact information.

18. The method of claim 14, wherein said web page for submission of user information is made at a web site hosted by a third party.
